(19) United States
(12) Patent Application Publication
(10) Pub. No.: US 2014/0184377 A1
(43) Pub. Date: Jul. 3, 2014

(54) INDUCTOR

(71) Applicant: SAMSUNG ELECTRO-MECHANICS CO., LTD., Suwon-si (KR)

(72) Inventors: Yong Suk KIM, Suwon-si (KR); Sung Kwon WI, Suwon-si (KR); Jong Yun LEE, Suwon-si (KR); Jin Woo HAHN, Suwon-si (KR); Young Seuck YOO, Suwon-si (KR)

(73) Assignee: SAMSUNG ELECTRO-MECHANICS CO., LTD., Suwon-si (KR)

(21) Appl. No.: 14/142,696

(22) Filed: Dec. 27, 2013

(30) Foreign Application Priority Data
Dec. 28, 2012 (JP) 10-2012-0157164

(51) Int. Cl. H01F 27/28

(52) U.S. Cl. CPC H01F 27/2804
USPC 336/200

(57) ABSTRACT

Disclosed herein is an inductor including: a substrate; an insulating part provided on the substrate; and a conductive pattern part provided in the insulating part, wherein the insulating part includes first and second insulating parts that are provided at regions physically separated from each other, the first and second insulating parts being made of materials of which at least one of dielectric constant and heat resistance are different. In the inductor according to the present invention, high Q and L values may be implemented, and deformation by heat treatment may also be decreased, thereby making it possible to improve reliability.

### CROSS REFERENCE(S) TO RELATED APPLICATIONS

This application claims the benefit under 35 U.S.C. Section 119 of Korean Patent Application Serial No. 10-2012-0157164, entitled “Inductor” filed on Dec. 28, 2012, which is hereby incorporated by reference in its entirety into this application.

### BACKGROUND OF THE INVENTION

1. Technical Field

The present invention relates to an inductor.

2. Description of the Related Art

An inductor is one of the important passive devices configuring an electronic circuit together with a resistor and a capacitor and used as a component for removing noise or configuring an LC resonance circuit.

This inductor is classified into a winding inductor manufactured by winding or printing a coil around a ferrite core and forming electrodes at both ends of the core, a multi-layer inductor manufactured by printing an internal electrode on one surface of a magnetic sheet or dielectric sheet and multi-layering the sheet, a thin film inductor manufactured by plating a coil shaped internal electrode on a base substrate through a thin film process, and the like.

Meanwhile, in accordance with miniaturization and high performance of mobile devices, electronic components mounted in the mobile devices should also be miniaturized.

In order to correspond to the mobile device, particularly, a wireless communication module such as a radio frequency (RF) module, and the like, having a small size and a high frequency, the inductor should have high precision and high Q characteristics.

The general inductor according to the related art as disclosed in Patent Document 1 was manufactured by multilayering a plurality of coils formed by printing a conductive pattern on an insulating layer and then performing compressing and firing processes.

However, in these inductors according to the related art, deformation of the conductive pattern may be easily generated due to the phenomenon such as blurring of an electrode during a printing process, alignment twisting or pressing of the electrode during multi-layering and compressing processes, or the like, and deformation of the conductive pattern was aggravated by shrinkage at the time of firing.

Therefore, it may be difficult to precisely implement desired inductance, and direct current resistance may be increased, or the like. As a result, it was difficult to secure the high-Q characteristics required for the high frequency inductor.

### RELATED ART DOCUMENT

### Patent Document

(Patent Document 1) Japanese Patent Laid-open Publication No. 2011-204899

### SUMMARY OF THE INVENTION

An object of the present invention is to provide an inductor having improved characteristics.

According to an exemplary embodiment of the present invention, there is provided an inductor including: a substrate; an insulating part provided on the substrate; and a conductive pattern part provided in the insulating part, wherein the insulating part includes first and second insulating parts that are provided at regions physically separated from each other, the first and second insulating parts being made of materials of which at least one of dielectric constant and heat resistance are different.

The first insulating part may be made of at least one material selected from a liquid crystal polymer, epoxy, polyimide, acrylic, and Teflon.

The second insulating part may be made of at least one material selected from oxide ceramic, nitride ceramic, and carbide ceramic.

The second insulating part may be made of at least one material selected from alumina, zirconia, titania, silica, aluminum nitride, silicon nitride, silicon carbide, and titanium carbide.

The second insulating part may cover all of the outer side surfaces of the first insulating part.

The conductor pattern part may include a conductor coil formed by winding a conductive material at least one turn, wherein the conductive coil is provided in the first insulating part.

The first and second insulating parts may be provided at regions at which they are not overlapped with each other in a vertical direction, wherein the first insulating part is positioned at an outline of the insulating part, and the second insulating part is positioned at a central portion thereof.

The conductive coil may be provided in the second insulating part.

The first and second insulating parts may be provided at regions at which they are not overlapped with each other in a vertical direction, wherein the second insulating part is positioned at an outline of the insulating part, and the first insulating part is positioned at a central portion thereof.

The conductive coil may be provided in the first insulating part.

The first insulating part may be provided on an upper surface of the substrate, the second insulating part may be provided on an upper surface of the first insulating part, and the conductive coil may be provided in the first insulating part.

### BRIEF DESCRIPTION OF THE DRAWINGS

FIG. 1 is a perspective view schematically showing an inductor according to an exemplary embodiment of the present invention.

FIG. 2 is a plan view schematically showing a shape of a first layer coil in the inductor according to the exemplary embodiment of the present invention.

FIG. 3 is a plan view schematically showing a shape of a second layer coil in the inductor according to the exemplary embodiment of the present invention.

FIG. 4 is a cross-sectional view taken along the line I-I′ of FIG. 1.

FIG. 5A is a schematic cross-sectional view taken along the line I-I′ of FIG. 1 in an inductor according to another exemplary embodiment of the present invention.

FIG. 5B is a plan view schematically showing a plan shape of a state in which an external electrode is removed from FIG. 5A.

FIG. 6A is a schematic cross-sectional view taken along the line I-I′ of FIG. 1 in an inductor according to another exemplary embodiment of the present invention.

FIG. 6B is a plan view schematically showing a plan shape of a state in which an external electrode is removed from FIG. 6A.

FIG. 7A is a schematic cross-sectional view taken along the line I-I′ of FIG. 1 in an inductor according to still another exemplary embodiment of the present invention.

FIG. 7B is a plan view schematically showing a plan shape of a state in which an external electrode is removed from FIG. 7A.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

For simplification and clearness of the illustration, a general configuration scheme will be shown in the accompanying drawings, and a detailed description of the feature and the technology well known in the art will be omitted in order to prevent a discussion of the exemplary embodiments of the present invention from being unnecessarily obscure. Additionally, components shown in the accompanying drawings are not necessarily shown to scale. For example, sizes of some components shown in the accompanying drawings may be exaggerated as compared with other components in order to assist in understanding the exemplary embodiments of the present invention. Like reference numerals on different drawings will denote like components, and similar reference numerals on different drawings will denote similar components, but are not necessarily limited thereto.

In the specification and the claims, terms such as “first”, “second”, “third”, “fourth”, and the like, if any, will be used to distinguish similar components from each other and be used to describe a specific sequence or a generation sequence, but is not necessarily limited thereto. It may be understood that these terms are compatible with each other under an appropriate environment so that exemplary embodiments of the present invention to be described below may be operated in a sequence different from a sequence shown or described herein. Likewise, in the present specification, in the case in which it is described that a method includes a series of steps, a sequence of these steps suggested herein is not necessarily a sequence in which these steps may be executed. That is, any described step may be omitted and/or any other step that is not described herein may be added to the method.

In the specification and the claims, terms such as “left”, “right”, “front”, “rear”, “top, “bottom”, “over”, “under”, and the like, if any, do not necessarily indicate relative positions that are not changed, but are used for description. It may be understood that these terms are compatible with each other under an appropriate environment so that exemplary embodiments of the present invention to be described below may be operated in a direction different from a direction shown or described herein. A term “connected” used herein is defined as being directly or indirectly connected in an electrical or non-electrical scheme. Targets described as being “adjacent to” each other may physically contact each other, be close to each other, or be in the same general range or region, in the context in which the above phrase is used. Here, a phrase “in an exemplary embodiment” means the same exemplary embodiment, but is not necessarily limited thereto.

Hereinafter, a configuration and an acting effect of exemplary embodiments of the present invention will be described in more detail with reference to the accompanying drawings.

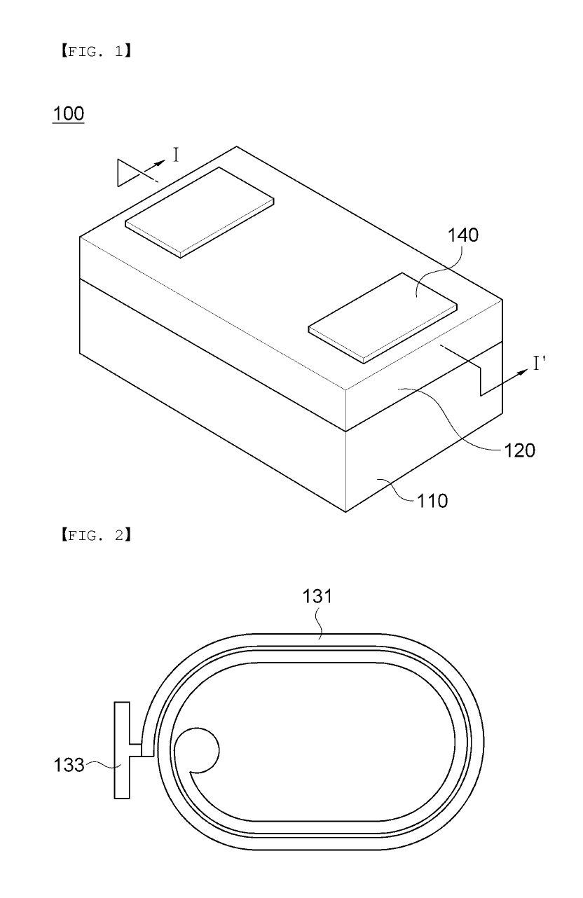

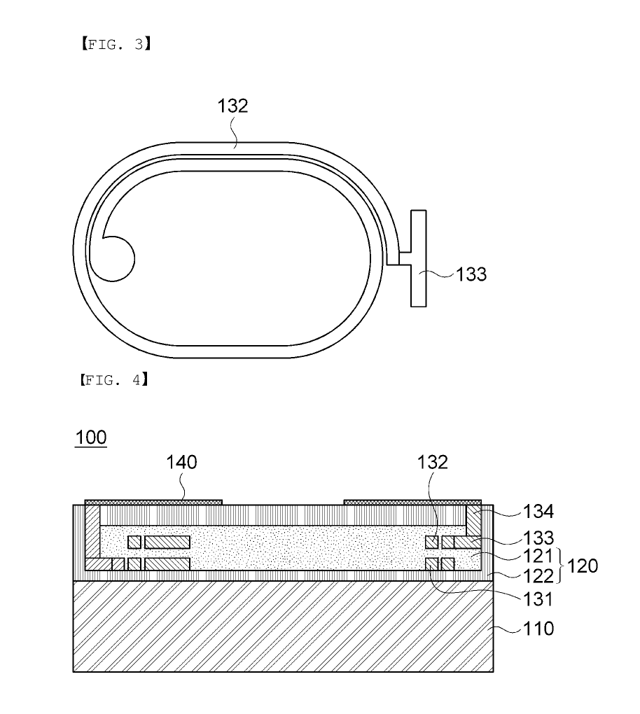

FIG. 1 is a perspective view schematically showing an inductor 100 according to an exemplary embodiment of the present invention; FIG. 2 is a plan view schematically showing a state in which a first layer coil 131 is formed in the inductor 100 according to the exemplary embodiment of the present invention; FIG. 3 is a plan view schematically showing a state in which a second layer coil 132 is formed in the inductor 100 according to the exemplary embodiment of the present invention; and FIG. 4 is a cross-sectional view taken along the line I-I′ of FIG. 1.

Referring to FIGS. 1 to 4, the inductor 100 according to the exemplary embodiment of the present invention may include a substrate 110, an insulating part 120, and a conductor pattern part.

The substrate 110 may be made of a material comprising a magnetic material such as ferrite, or the like.

The insulating part 120 may be provided on the substrate 110 and include the conductive pattern part therein.

The conductive pattern part may include a conductor coil, an internal terminal 133, and a connection terminal 134.

Here, the case in which the conductor coil includes the first and second layer coils 131 and 132 to be formed in two layers is shown in the drawings, but the present invention is not limited thereto. That is, the conductor coil may be formed in one layer or three or more layers.

The internal terminals 133 may be provided at one end and the other end of the coil, respectively, and exposed to the outside of the inductor 100 through the connection terminal 134.

In this case, as shown in the drawings, external electrodes 140 connected to the internal terminal 133 may be further provided at the outside of the inductor 100. Therefore, convenience in a process and reliability of connection during a coupling process of connecting the inductor to other devices may be improved.

The first layer coil 131, the second layer coil 132, the internal terminal 133, the connection terminal 134, and the like, as described above, may be formed by a multi-layering method or by a photo-resist method.

Meanwhile, in the inductor 100 according to the exemplary embodiment of the present invention, the insulating part 120 is configured of a first insulating part 121 and a second insulating part 122. In this case, the first and second insulating parts 121 and 122 may be made of materials of which at least one of dielectric constant and heat resistance are different from each other.

That is, the dielectric constant of the first insulating part 121 may be higher than that of the second insulating part 122, and heat resistance of the second insulating part 122 may be higher than that of the first insulating part 121.

For example, the first insulating part 121 may be made of at least one material selected from a liquid crystal polymer, epoxy, polyimide, acrylic and Teflon.

In addition, the second insulating part 122 may be made of at least one material selected from oxide ceramic, nitride ceramic, and carbide ceramic.

In this case, as the oxide ceramic, alumina, zirconia, titania, silica, or the like, may be used, as the nitride ceramic, aluminum nitride, silicon nitride, or the like, may be used, and as the carbide ceramic, silicon carbide, titanium carbide, or the like, may be used.

Therefore, since the first insulating part 121 has a low dielectric constant, Q or L characteristics of the inductor 100 may be improved.

In addition, since the second insulating part 122 has high heat resistance, a phenomenon that the conductor pattern is deformed, or the like, may be decreased even in a high temperature environment during a manufacturing process of the inductor 100.

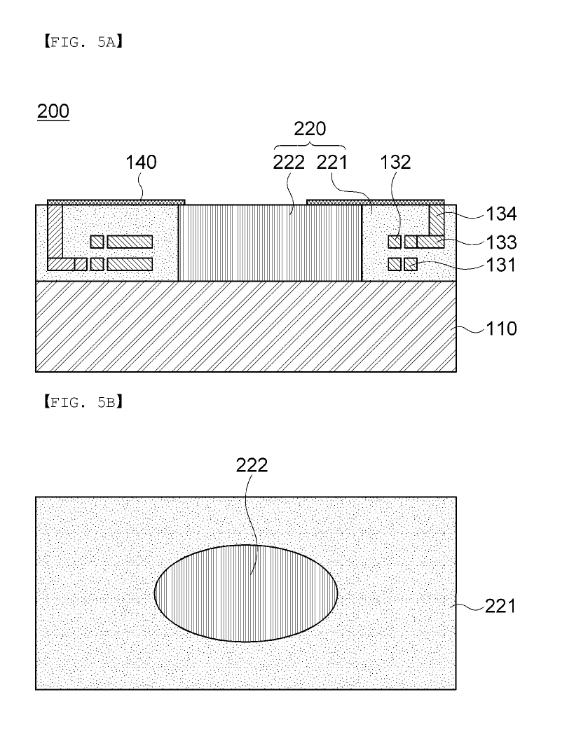

FIGS. 5A to 7B show arrangement relationship between a first insulating part 221, 321, or 421 and a second insulating part 222, 322, or 422 in an inductor 200, 300, or 400 according to various embodiments of the present invention.

That is, the arrangement relationship between the first insulating part 121, 221, 321, or 421 and the second insulating part 122, 222, 322, or 422 may be variously changed as needed. Hereinafter, referring to FIGS. 1 to 7B, the arrangement relationship between the first insulating part 121, 221, 321, or 421 and the second insulating part 122, 222, 322, or 422 and relationship between characteristics, a deformation degree, and a shrinkage ratio of the inductor 100, 200, 300, or 400 according to the arrangement relationship will be described.

First, referring to FIG. 4, the second insulating part 122 may entirely cover an outer side surface of the insulating part 121, and the conductor coil may be provided in the first insulating part 121.

The characteristics, the deformation degree, and the shrinkage ratio of the inductor 100 according to Experimental Example 1 were shown in the following Table 1.

### Experimental Example 1

Inductor 100: Width/length/thickness: 0.6 mm/0.3 mm/0.3 mm
Thickness of substrate 110: 0.2 mm
Thickness of insulating part 120: 0.1 mm
The sum of turns of first and second layer coils 131 and 132: 3.5 turns
Line width/thickness/interval of first and second layer coils 131 and 132: 22/10/20 um
Thickness of first and second layer coils 131 and 132: 10 um
Arrangement relationship between first and second insulating parts 121 and 122: They were arranged as shown in FIG. 4
L and Q were measured at a frequency of 2.4 GHz.
The deformation degree was measured after the inductor was heat treated at 210° C. for 3 hours.
The shrinkage ratio was calculated by measuring a shrinkage degree of the inductor in a thickness direction before and after heat-treatment.

TABLE 1

| | | | Deformation | Shrinkage |
|---|---|---|---|---|
| Classification | L(nH) | Q | degree (um) | ratio (%) |
| #1 | 5.6 | 45 | 3 | 15 |
| #2 | 5.8 | 43 | 3 | 16 |
| #3 | 5.6 | 44 | 4 | 14 |
| #4 | 5.5 | 45 | 3 | 15 |
| #5 | 5.6 | 45 | 4 | 15 |
| #6 | 5.6 | 46 | 3 | 16 |
| #7 | 5.7 | 45 | 3 | 17 |
| #8 | 5.5 | 44 | 4 | 14 |
| #9 | 5.6 | 46 | 4 | 15 |
| #10 | 5.5 | 44 | 3 | 15 |
| Average | 5.6 | 44.7 | 3.4 | 15.2 |

Next, referring to FIGS. 5A and 5B, the first insulating part 221 may be positioned at an outline of the insulating part 220, and the second insulating part 222 may be positioned at a central portion of the insulating part 220. In this case, the first and second insulating parts 221 and 222 are provided at regions at which they are not overlapped with each other in a vertical direction. That is, lower surfaces of the first and second insulating parts 221 and 222 may contact the substrate 110, and upper surfaces of the first and second insulating parts 221 and 222 may form an upper surface of the inductor 200.

Further, in this case, a conductor coil may be provided in the first insulating part 221.

The characteristics, the deformation degree, and the shrinkage ratio of the inductor 200 according to Experimental Example 2 were shown in the following Table 2.

### Experimental Example 2

Inductor 200: Width/length/thickness: 0.6 mm/0.3 mm/0.3 mm
Thickness of substrate 110: 0.2 mm
Thickness of insulating part 220: 0.1 mm
The sum of turns of first and second layer coils 231 and 232: 3.5 turns
Line width/thickness/interval of first and second layer coils 231 and 232: 22/10/20 um
Thickness of first and second layer coils 231 and 232: 10 um
Arrangement relationship between first and second insulating parts 221 and 222: They were arranged as shown in FIGS. 5A and 5B.
L and Q were measured at a frequency of 2.4 GHz.
Deformation degree was measured after the inductor was heat treated at 210° C. for 3 hours.
The shrinkage ratio was calculated by measuring a shrinkage degree of the inductor in a thickness direction before and after heat-treatment.

TABLE 2

| | | | Deformation | Shrinkage |
|---|---|---|---|---|
| Classification | L(nH) | Q | degree (um) | ratio (%) |
| #11 | 5.5 | 42 | 6 | 31 |
| #12 | 5.4 | 40 | 5 | 30 |
| #13 | 5.5 | 42 | 6 | 31 |
| #14 | 5.4 | 41 | 7 | 32 |
| #15 | 5.5 | 40 | 6 | 30 |
| #16 | 5.4 | 41 | 5 | 29 |
| #17 | 5.6 | 40 | 6 | 31 |
| #18 | 5.4 | 42 | 6 | 30 |
| #19 | 5.5 | 42 | 7 | 30 |
| #20 | 5.5 | 41 | 5 | 30 |
| Average | 5.47 | 41.1 | 5.9 | 30.4 |

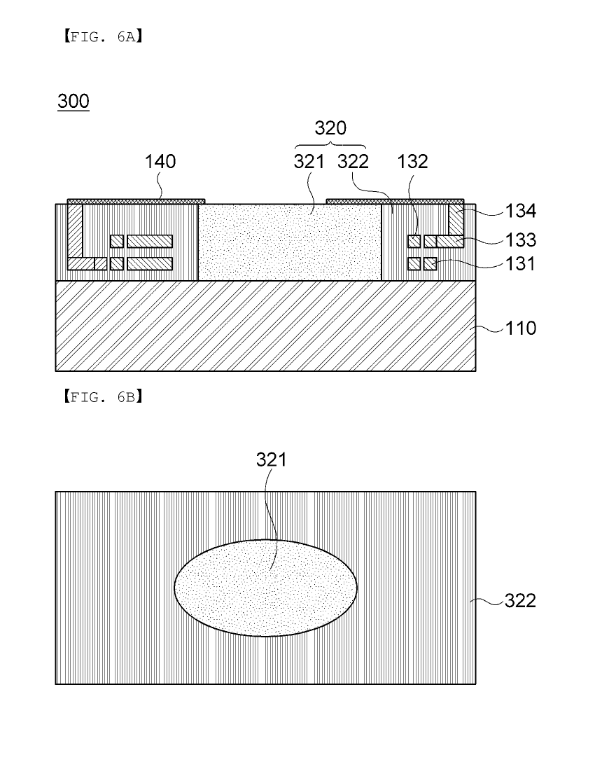

Next, referring to FIGS. 6A and 6B, the second insulating part 322 may be positioned at an outline of the insulating part 320, and the first insulating part 321 may be positioned at a central portion of the insulating part 320. In this case, the first and second insulating parts 321 and 322 are provided at regions at which they are not overlapped with each other in a vertical direction. That is, lower surfaces of the first and second insulating parts 321 and 322 may contact the substrate 110, and upper surfaces of the first and second insulating parts 321 and 322 may form an upper surface of the inductor 300.

Further, in this case, a conductor coil may be provided in the second insulating part 322.

The characteristics, the deformation degree, and the shrinkage ratio of the inductor 300 according to Experimental Example 3 were shown in the following Table 3.

### Experimental Example 3

Inductor 300: Width/length/thickness: 0.6 mm/0.3 mm/0.3 mm
Thickness of substrate 110: 0.2 mm
Thickness of insulating part 320: 0.1 mm
The sum of turns of first and second layer coils 331 and 332: 3.5 turns
Line width/thickness/interval of first and second layer coils 331 and 332: 22/10/20 um
Thickness of first and second layer coils 331 and 332: 10 um
Arrangement relationship between first and second insulating parts 321 and 322: They were arranged as shown in FIGS. 6A and 6B.
L and Q were measured at a frequency of 2.4 GHz.
Deformation degree was measured after the inductor was heat treated at 210° C. for 3 hours.
The shrinkage ratio was calculated by measuring a shrinkage degree of the inductor in a thickness direction before and after heat-treatment.

TABLE 3

| | | | Deformation | Shrinkage |
|---|---|---|---|---|
| Classification | L(nH) | Q | degree (um) | ratio (%) |
| #21 | 5.3 | 37 | 4 | 13 |
| #22 | 5.4 | 36 | 4 | 12 |
| #23 | 5.4 | 38 | 4 | 13 |
| #24 | 5.3 | 37 | 5 | 13 |
| #25 | 5.2 | 37 | 3 | 14 |
| #26 | 5.3 | 36 | 5 | 13 |
| #27 | 5.2 | 38 | 4 | 14 |
| #28 | 5.3 | 37 | 4 | 12 |
| #29 | 5.4 | 37 | 3 | 13 |
| #30 | 5.3 | 37 | 3 | 14 |
| Average | 5.31 | 37 | 3.9 | 13.1 |

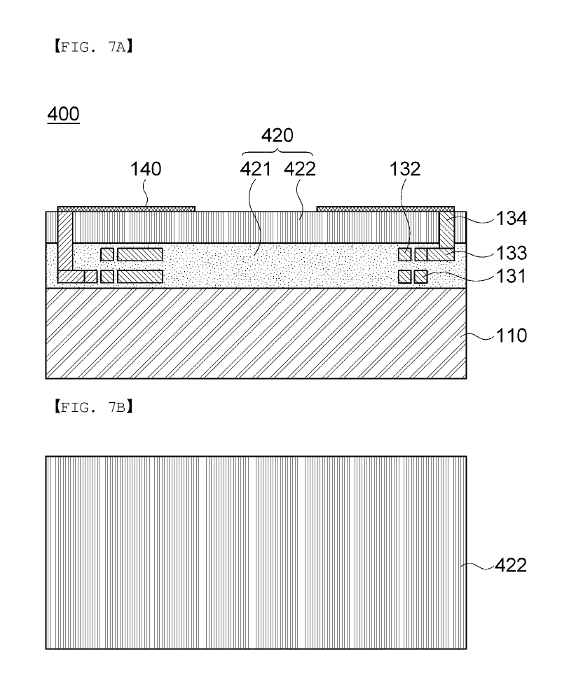

Next, referring to FIGS. 7A and 7B, the first insulating part 421 may be provided on the insulating part 110, and the second insulating part 422 may be provided on the first insulating part 421.

Further, in this case, a conductor coil may be provided in the first insulating part 421.

The characteristics, the deformation degree, and the shrinkage ratio of the inductor 400 according to Experimental Example 4 were shown in the following Table 4.

### Experimental Example 4

Inductor 400: Width/length/thickness: 0.6 mm/0.3 mm/0.3 mm
Thickness of substrate 110: 0.2 mm
Thickness of insulating part 420: 0.1 mm
The sum of turns of first and second layer coils 431 and 432: 3.5 turns
Line width/thickness/interval of first and second layer coils 431 and 432: 22/10/20 um
Thickness of first and second layer coils 431 and 432: 10 um
Arrangement relationship between first and second insulating parts 421 and 422: They were arranged as shown in FIGS. 7A and 7B.
L and Q were measured at a frequency of 2.4 GHz.
Deformation degree was measured after the inductor was heat treated at 210° C. for 3 hours.
The shrinkage ratio was calculated by measuring a shrinkage degree of the inductor in a thickness direction before and after heat-treatment.

TABLE 4

| | | | Deformation | Shrinkage |
|---|---|---|---|---|
| Classification | L(nH) | Q | degree (um) | ratio (%) |
| #31 | 5.5 | 45 | 10 | 21 |
| #32 | 5.6 | 44 | 10 | 22 |
| #33 | 5.7 | 45 | 9 | 20 |
| #34 | 5.6 | 43 | 11 | 20 |
| #35 | 5.8 | 44 | 12 | 19 |
| #36 | 5.7 | 45 | 9 | 21 |
| #37 | 5.6 | 45 | 10 | 20 |
| #38 | 5.7 | 43 | 10 | 21 |
| #39 | 5.6 | 44 | 9 | 22 |
| #40 | 5.7 | 44 | 10 | 20 |
| Average | 5.65 | 44.2 | 10 | 20.6 |

The averages in Tables 1 to 4 were arranged and shown in the following Table 5.

TABLE 5

| | | | Deformation | Shrinkage |
|---|---|---|---|---|
| Classification | L(nH) | Q | degree (um) | ratio (%) |
| Experimental | 5.60 | 44.7 | 3.4 | 15.2 |
| Example 1 | | | | |
| Experimental | 5.47 | 41.1 | 5.9 | 30.4 |
| Example 2 | | | | |
| Experimental | 5.31 | 37.0 | 3.9 | 13.1 |
| Example 3 | | | | |
| Experimental | 5.65 | 44.2 | 10.0 | 20.6 |
| Example 4 | | | | |

As shown in Table 5, the deformation degree and the shrinkage ratio as well as L and Q values, which are characteristics of the inductor 100, 200, 300, or 400 were changed according to the arrangement relationship between the first insulating part 121, 221, 321, or 421 and the second insulating part 122, 222, 322, or 422.

Particularly, the L and Q values were relatively high in Experimental Examples 1 and 4, but the deformation degree and the shrinkage ratio also rapidly increased in Experimental Example 4. Therefore, it may be appreciated that the embodiment applied to the Experimental Example 1 was preferable.

Meanwhile, comparing the Experimental Examples 1 and 3 with each other, it may be appreciated that in the case of Experimental Example 3, the deformation degrees and the shrinkage ratios were similar, but the L and Q values were lower than those in Experimental Example 1. Actually, since various kinds of inductors having different L and Q values are used in the industry as needed, the inductor 100 having a structure in Experimental Example 1 or the inductor 300 having a structure in Experimental Example 3 may be selectively used as needed.

In addition, in the embodiments applied to Experimental Example 2 or 4, even though a degree of improving the performance is slight as compared with other Experimental Examples, the deformation degree and shrinkage ratio are decreased in addition to improvement of characteristics value. Therefore, the embodiment in Experimental Example 2 or 4 may be used in the industry.

With the inductor according to the exemplary embodiment of the present invention configured as described above, high Q and L value may be implemented, and deformation by heat treatment may be decreased, thereby making it possible to improve reliability.

Although the exemplary embodiments of the present invention have been disclosed for illustrative purposes, those skilled in the art will appreciate that various modifications, additions, and substitutions are possible, without departing from the scope and spirit of the invention as disclosed in the accompanying claims. Accordingly, such modifications, additions, and substitutions should also be understood to fall within the scope of the present invention.

What is claimed is:

1. An inductor comprising:
a substrate;
an insulating part provided on the substrate; and
a conductive pattern part provided in the insulating part,
wherein the insulating part includes first and second insulating parts that are provided at regions physically separated from each other,
the second insulating part covers all of the outer side surfaces of the first insulating part,
the first and second insulating parts being made of materials of which at least one of dielectric constant and heat resistance are different from each other.

2. The inductor according to claim 1, wherein the first insulating part is made of at least one material selected from a liquid crystal polymer, epoxy, polyimide, acrylic, and Teflon.

3. The inductor according to claim 2, wherein the second insulating part is made of at least one material selected from oxide ceramic, nitride ceramic, and carbide ceramic.

4. The inductor according to claim 2, wherein the second insulating part is made of at least one material selected from alumina, zirconia, titania, silica, aluminum nitride, silicon nitride, silicon carbide, and titanium carbide.

5. The inductor according to claim 1, wherein the conductor pattern part includes a conductor coil formed by winding a conductive material at least one turn,
the conductive coil being provided in the first insulating part.

6. An inductor comprising:
a substrate;
an insulating part provided on the substrate; and
a conductive pattern part provided in the insulating part,
wherein the insulating part includes first and second insulating parts that are provided at regions physically separated from each other,
the first and second insulating parts are provided at regions at which they are not overlapped with each other in a vertical direction,
the first insulating part being positioned at an outline of the insulating part, and the second insulating part being positioned at a central portion thereof,
the first and second insulating parts being made of materials of which at least one of dielectric constant and heat resistance are different.

7. The inductor according to claim 6, wherein the conductor pattern part includes a conductor coil formed by winding a conductive material at least one turn,
the conductive coil being provided in the first insulating part.

8. An inductor comprising:
a substrate;
an insulating part provided on the substrate; and
a conductive pattern part provided in the insulating part,
wherein the insulating part includes first and second insulating parts that are provided at regions physically separated from each other,
the first and second insulating parts are provided at regions at which they are not overlapped with each other in a vertical direction,
the second insulating part being positioned at an outline of the insulating part, and the first insulating part being positioned at a central portion thereof,
the first and second insulating parts being made of materials of which at least one of dielectric constant and heat resistance are different.

9. The inductor according to claim 8, wherein the conductor pattern part includes a conductor coil formed by winding a conductive material at least one turn,
the conductive coil being provided in the second insulating part.

10. An inductor comprising:
a substrate;
an insulating part provided on the substrate; and
a conductive pattern part provided in the insulating part,
wherein the insulating part includes first and second insulating parts that are provided at regions physically separated from each other,
the first insulating part is provided on an upper surface of the substrate, and the second insulating part is provided on an upper surface of the first insulating part,
the first and second insulating parts being made of materials of which at least one of dielectric constant and heat resistance are different.

11. The inductor according to claim 10, wherein the conductor pattern part includes a conductor coil formed by winding a conductive material at least one turn,
the conductive coil being provided in the first insulating part.
